(19) United States
(12) Patent Application Publication
(10) Pub. No.: US 2008/0071755 A1
(43) Pub. Date: Mar. 20, 2008

(54) RE-ALLOCATION OF RESOURCES FOR QUERY EXECUTION IN PARTITIONS

(76) Inventors: Eric L. Barsness, Pine Island, MN (US); John M. Santosuosso, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/468,913

(22) Filed: Aug. 31, 2006

(51) Int. Cl. G06F 17/30

(52) U.S. Cl. 707/4

(57) ABSTRACT

Embodiments of the invention provide methods, systems, and articles of manufacture for executing a query against a partitioned database. The query may be executed against each partition of the database to retrieve results from each partition. The results from the partitions may be integrated to provide the results of the query. Each partition may take different amounts of time to retrieve results for the query. Embodiments of the invention allow reallocation of resources to logical partitions of a system executing the query based on the relative execution times of the query for the various database partitions.

### BACKGROUND OF THE INVENTION

1. Field of the Invention

The present invention generally relates to data processing, and more specifically to executing queries against a partitioned database.

2. Description of the Related Art

Databases are computerized information storage and retrieval systems. A relational database management system (RDBMS) is a database management system (DBMS) that uses techniques for storing and retrieving data. The most prevalent type of database is the relational database, a tabular database in which data is defined so that it can be reorganized and accessed in a number of different ways.

Databases are typically partitioned to improve availability, performance, and scalability. Partitioning a database involves dividing the database or its constituent elements into distinct individual parts. For example, a database may be partitioned by building smaller separate databases, each with its own tables, indexes, transaction logs, etc. or by splitting a selected element, for example a field of a table. The database may be partitioned within a single server, or distributed or replicated across multiple servers. Therefore, database partitioning provides multiple benefits including scalability to support large databases, the ability to handle complex workloads, and increased parallelism.

When queries are run against a partitioned database, the query may be run against each database partition. The results from each database partition may then be integrated to provide the result for the query. To further improve performance of querying a database, the query may not be run against one or more database partitions which are known to not contain results for the query. For example, a database may be partitioned based on location. The locations, for example, may be divided into 4 database partitions, each partition being associated with data from one of the eastern states, western states, northern states, and southern states.

If a query containing a condition STATE=‘MAINE’ is run against the database, the query need not be run against database partitions containing data for southern and western states. Therefore, by eliminating the number of database partitions against which a query is executed, the performance may be improved. However, even with elimination of database partitions, the query may still be run against multiple database partitions. For example, the above query may be executed against the northern states partition and the eastern states partition.

One problem with running a query against multiple database partitions is that the response time for running the query against each database partition may be different. For example, if the above query is run against the database partitions containing data for the northern and eastern states, the northern states partition may take longer time to retrieve results than the southern states partition. Therefore, the response time of the query is governed by the slowest partition returning results to satisfy the query.

In a logically partitioned system, executing the query against some database partitions may take longer because sufficient resources may not be available to the logical partition executing the query. For example, a logical partition may not have sufficient memory allocated to the logical partition, thereby slowing execution of a query requiring heavy memory usage. Dedicating such critical resources to other logical partitions which do not require as much memory usage is inefficient because the complete result set for the above query is not returned to the user until the results from the slowest database partition are available. Furthermore, a significant amount of time may be wasted while waiting for the slower partition to retrieve results. Therefore overall query throughput may be adversely affected.

Accordingly, what is needed are improved methods, systems, and articles of manufacture for improving query throughput in a partitioned database environment.

### SUMMARY OF THE INVENTION

The present invention generally relates to data processing, and more specifically to executing queries against a partitioned database.

One embodiment of the invention provides a method for executing a query. The method generally comprises determining a query resource requirement for execution of the query in a partitioned data environment having a plurality of data partitions, adjusting allocation of resources to one or more logical partitions executing the query against one or more data partitions based on the determined query resource requirement, and executing the query in a plurality of logical partitions including the one or more logical partitions for which resources were adjusted.

Another embodiment of the invention provides a computer readable medium containing a program for executing a query which, when executed, performs an operation for executing a query. The operation generally comprises determining a query resource requirement for execution of the query in a partitioned data environment having a plurality of data partitions, adjusting allocation of resources to one or more logical partitions executing the query against one or more data partitions based on the determined query resource requirement, and executing the query in a plurality of logical partitions including the one or more logical partitions for which resources were adjusted.

Yet another embodiment of the invention provides a system generally comprising a database comprising a plurality of data partitions and a plurality of logical partitions, wherein each logical partition is configured to execute a query against one or more data partitions. The system may also include a partition manager configured to adjust allocation of resources to one or more logical partitions executing the query against one or more data partitions based on a query resource requirement for executing the query, and execute the query in the plurality of logical partitions including the one or more logical partitions for which resources were adjusted.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of an exemplary system according to an embodiment of the invention.

FIG. 2 is an illustration of a partitioned database, according to an embodiment of the invention.

FIG. 3 is an exemplary timeline for execution of a query against a plurality of partitions, according to an embodiment of the invention.

FIG. 4 is an illustration of another system according to an embodiment of the invention.

FIG. 5 is a flow diagram of exemplary operations performed to reallocate resources among logical partitions.

FIG. 6 illustrates reallocation of memory according to an embodiment of the invention.

### DETAILED DESCRIPTION

Embodiments of the invention provide methods, systems, and articles of manufacture for executing a query against a partitioned database. The query may be executed against each partition of the database to retrieve results from each partition. The results from the partitions may be integrated to provide the results of the query. Each partition may take different amounts of time to retrieve results for the query. Embodiments of the invention allow reallocation of resources to logical partitions of a system executing the query based on the relative execution times of the query for the various database partitions.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

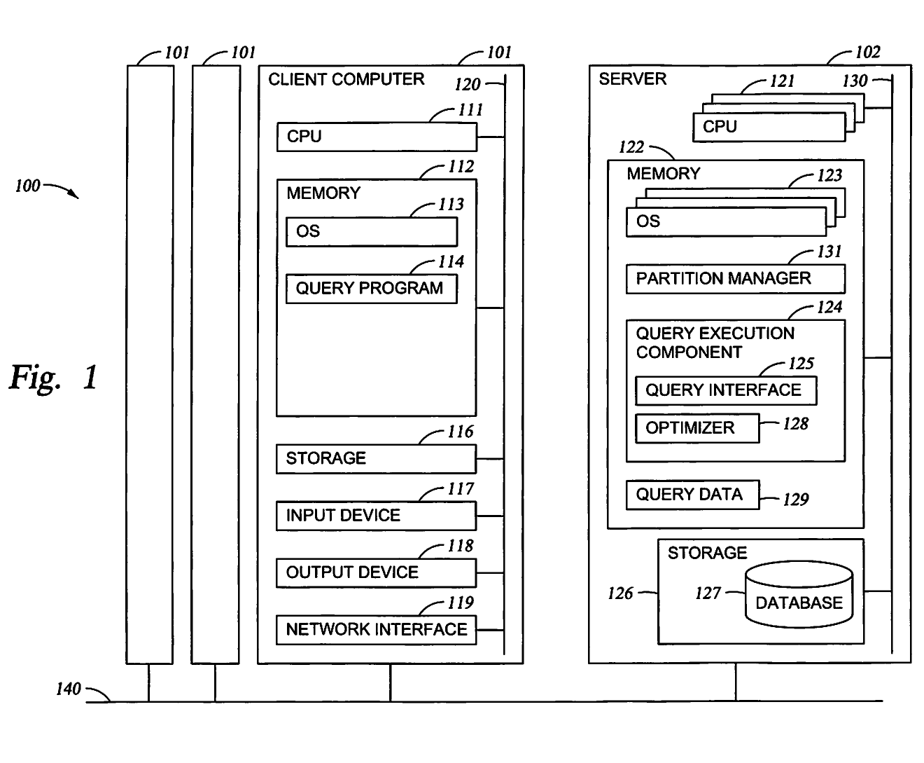

One embodiment of the invention is implemented as a program product for use with a computer system such as, for example, the network environment 100 shown in FIG. 1 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

### Exemplary System

FIG. 1 depicts a block diagram of a networked system 100 in which embodiments of the invention may be implemented. In general, the networked system 100 includes a client (e.g., user's) computer 101 (three such client computers 101 are shown) and at least one server 102 (one such server 102 shown). The client computers 101 and server 102 are connected via a network 140. In general, the network 140 may be a local area network (LAN) and/or a wide area network (WAN). In a particular embodiment, the network 140 is the Internet.

The client computer 101 includes a Central Processing Unit (CPU) 111 connected via a bus 120 to a memory 112, storage 116, an input device 117, an output device 118, and a network interface device 119. The input device 117 can be any device to give input to the client computer 101. For example, a keyboard, keypad, light-pen, touch-screen, track-ball, or speech recognition unit, audio/video player, and the like could be used. The output device 118 can be any device to give output to the user, e.g., any conventional display screen. Although shown separately from the input device 117, the output device 118 and input device 117 could be combined. For example, a display screen with an integrated touch-screen, a display with an integrated keyboard, or a speech recognition unit combined with a text speech converter could be used.

The network interface device 119 may be any entry/exit device configured to allow network communications between the client computers 101 and server 102 via the network 140. For example, the network interface device 119 may be a network adapter or other network interface card (NIC).

Storage 116 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 112 and storage 116 could be part of one virtual address space spanning multiple primary and secondary storage devices.

The memory 112 is preferably a random access memory sufficiently large to hold the necessary programming and data structures of the invention. While memory 112 is shown as a single entity, it should be understood that memory 112 may in fact comprise a plurality of modules, and that memory 112 may exist at multiple levels, from high speed registers and caches to lower speed but larger DRAM chips.

Illustratively, the memory 112 contains an operating system 113. Illustrative operating systems, which may be used to advantage, include Linux (Linux is a trademark of Linus Torvalds in the US, other countries, or both) and Microsoft's Windows®. More generally, any operating system supporting the functions disclosed herein may be used.

Memory 112 is also shown containing a query program 114 which, when executed by CPU 111, provides support for querying a server 102. In one embodiment, the query program 114 includes a web-based Graphical User Interface (GUI), which allows the user to display Hyper Text Markup Language (HTML) information. More generally, however, the query program may be a GUI-based program capable of rendering the information transferred between the client computer 101 and the server 102.

The server 102 may by physically arranged in a manner similar to the client computer 101. Accordingly, the server 102 is shown generally comprising one or more CPUs 121, a memory 122, and a storage device 126, coupled to one another by a bus 130. Memory 122 may be a random access memory sufficiently large to hold the necessary programming and data structures that are located on server 102.

In one embodiment of the invention server 102 may be a logically partitioned system, wherein each logical partition of the system is assigned one or more resources available of server 102. Accordingly, server 102 may generally be under the control of one or more operating systems 123 shown residing in memory 122. Each logical partition of server 102 may be under the control of one of the operating systems 123. Examples of the operating system 123 include IBM OS/400®, UNIX, Microsoft Windows®, and the like. More generally, any operating system capable of supporting the functions described herein may be used.

Accordingly, server 102 may include a partition manager 131 for handling logical partitioning of the system. In a particular embodiment, the partition manager 131 is implemented as a “Hypervisor,” a software component available from International Business Machines, Inc. of Armonk, N.Y. In one embodiment, partition manager 131 may generally be implemented as system firmware of server 102 to provide low-level partition management functions, such as transport control enablement, page-table management and contains the data and access methods needed to configure, service, and run multiple logical partitions. In one embodiment, partition manager 131 may generally handle higher-level logical partition management functions, such as virtual service processor functions, and starting/stopping partitions.

Each logical partition may be allocated a set of resources by partition manager 131. For example, each logical partition may be allocated a particular CPU, a range of memory, one or more IO ports, and the like. Embodiments of the invention allow dynamic adjustment of allocation of resources to the logical partitions based on query execution parameters. The adjustment of resource allocation is described in greater detail below.

Memory 122 may include a query execution component 124. The query execution component 124 may be a software product comprising a plurality of instructions that are resident at various times in various memory and storage devices in the computer system 100. For example, the query execution component 124 may contain a query interface 125. The query interface 125 (and more generally, any requesting entity, including the operating system 123) is configured to issue queries against a database 127 (shown in storage 126).

Query execution component 124 may also include an optimizer 128. Optimizer 128 may determine the most efficient way to execute a query. For example, optimizer 128 may consider a plurality of access plans for a given query and determine which of those plans will be the most efficient. Determining efficiency of an access plan may include determining an estimated cost for executing the query. The cost may be determined, for example, by available memory, number of Input/Output (IO) operations required to execute the query, CPU requirements, and the like.

In one embodiment of the invention, each logical partition of server 102 may include an associated optimizer 128, wherein the optimizer optimizes execution of queries executed by the respective logical partition.

Database 127 is representative of any collection of data regardless of the particular physical representation. By way of illustration, the database 127 may be organized according to a relational schema (accessible by SQL queries) or according to an XML schema (accessible by XML queries). However, the invention is not limited to a particular schema and contemplates extension to schemas presently unknown. As used herein, the term “schema” generically refers to a particular arrangement of data.

In one embodiment of the invention database 127 may be a partitioned database. Accordingly database 127 may be divided or broken into its constituent elements to create distinct individual parts. A database partition consists of its own data, indexes, configuration files, and transaction logs. A database partition is sometimes called a node or a database node. For example, database 127 may be partitioned by building smaller separate databases, each with its own tables, indexes, transaction logs, etc., or by splitting a selected element, for example a field of a table. Tables can be located in one or more database partitions. When a table's data is distributed across multiple database partitions, some of its rows are stored in one database partition, and other rows are stored in other database partitions. It should be noted that, in practice, partitioned databases used for commercial, scientific, medical, financial, etc. purposes would typically have hundreds or thousands (or more) of columns and in excess of millions of rows.

In one embodiment database 127 may contain one or more partitions of a larger database. Thus, in one embodiment, the individual partitions may be distributed over a plurality of servers (such as server 102. A query received from a client 102 may be executed against one or more of the partitions of the larger database contained in the one or more servers 102. Data retrieval and update requests are decomposed automatically into sub-requests, and executed in parallel among the applicable database partitions. The fact that databases are split across database partitions is transparent to users.

Typically, a single database partition exists on each physical component that makes up a computer. The processors on each system are used by the database manager at each database partition to manage its part of the total data in the database. Because data is divided across database partitions, the power of multiple processors on multiple computers may be used to satisfy requests for information. Data retrieval and update requests are decomposed automatically into subrequests and are executed in parallel among the applicable database partitions.

User interaction occurs through one database partition, known as the coordinator partition for that user. The coordinator runs on the same database partition as the application, or, in the case of a remote application, the database partition to which that application is connected. Any database partition can be used as a coordinator partition.

Memory 122 may also include query data 129. Query data 129 may include historical execution metrics for queries executed against one or more partitions of database 127. The execution metrics, for example, may include the query execution time for each partition of database 127.

### Adjusting Resource Allocation to Partitions

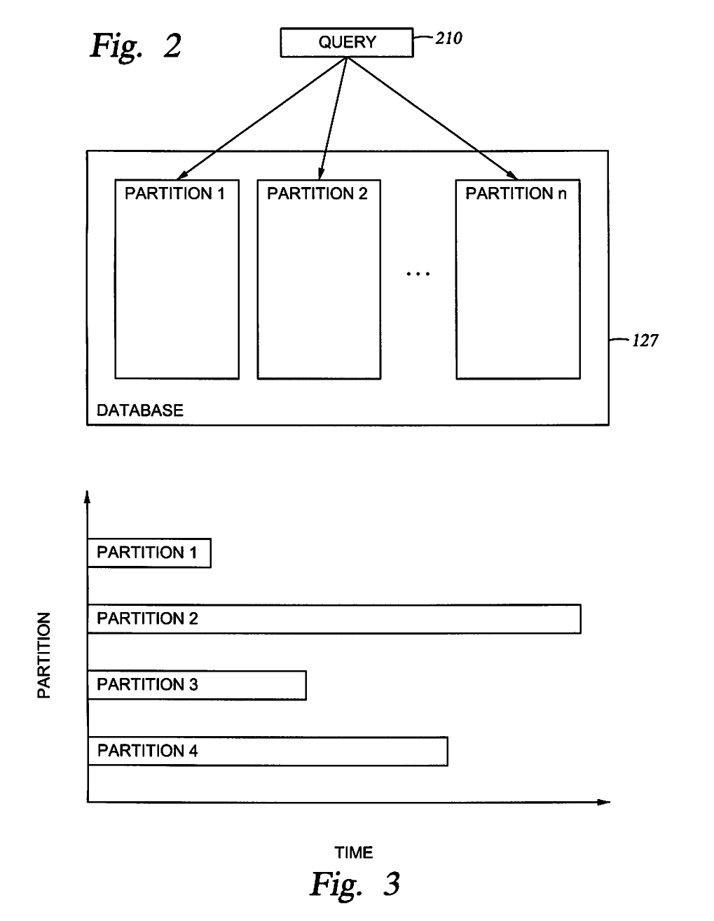

FIG. 2 is a block diagram of a partitioned database 127. As illustrated database 127 may include a plurality of partitions. For example, database partitions 1, 2, . . . n are shown. Executing a query against database 127 may involve running the query against one or more of the plurality of database partitions. For example, query 210 may be run against each of the database partitions 1-n. The results received from each database partition may be combined to provide the results for query 210.

Query 210 may include a set of commands or clauses for retrieving data stored in database 127. Query 210 may come from a client computer 102, an operating system, or a remote system. Query 210 may specify columns of database 127 from which data is to be retrieved, join criteria for joining columns from multiple tables, and conditions that must be satisfied for a particular data record to be included in a query result set.

One skilled in the art will recognize that when query 210 is executed against each database partition, each of database partitions 1-n may take a different amount of time to retrieve results for the query. Factors affecting the time taken to retrieve results for a given database partition may include the size of the partition and availability of resources such as CPU and memory to execute the query, clock speed, and the like.

FIG. 3 illustrates an exemplary timeline depicting the different times that may be taken by different database partitions to retrieve results for a query. As illustrated database partition 1 takes the shortest time to retrieve results and database partition 2 takes the longest time to retrieve results. Therefore, partition 2 is the slowest member of the database partition group determining the query response time.

Because database partition 2 has the longest response time, database partition 2 determines the execution time for the query as a whole. Embodiments of the invention provide for adjusting resources allocated to a logical partition executing the query against a database partition with the longest response time, thereby reducing query execution time and increasing overall query throughput. For example, the logical partition with the longest response time may be allocated more memory or CPUs to allow the query to execute faster.

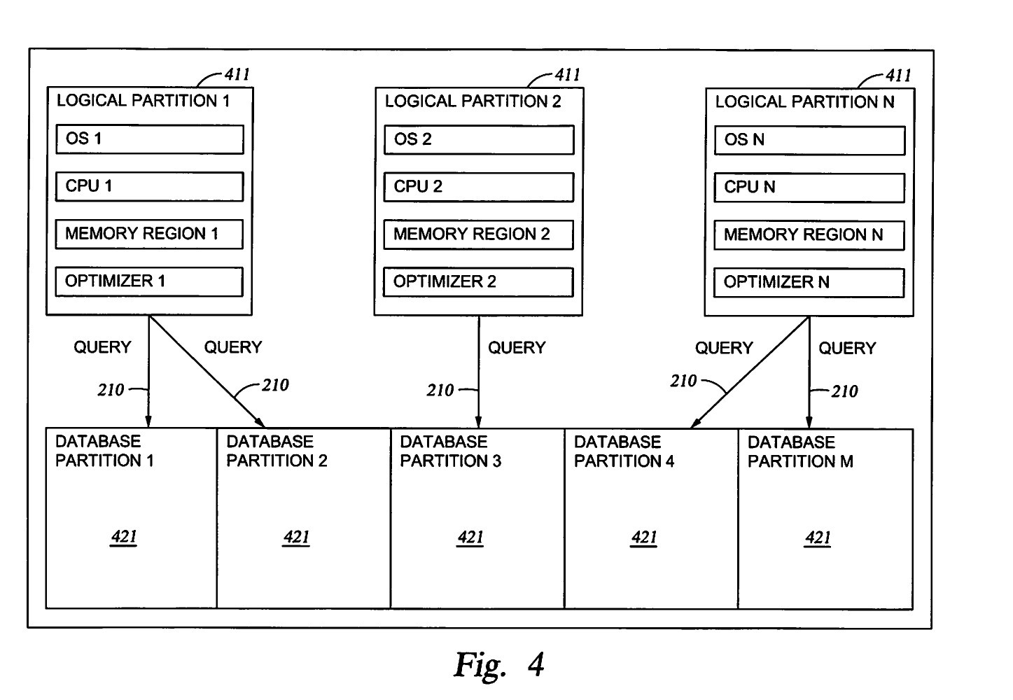

FIG. 4 illustrates an exemplary logically partitioned system 400 according to an embodiment of the invention. One skilled in the art will recognize that logically partition system 400 is an embodiment of server 102 illustrated in FIG. 1. System 400 may include a plurality of logical partitions 411. For example, logical partitions 1 N are shown in FIG. 4. System 400 may also include a partitioned database 127. Accordingly, database 127 is shown including a plurality of database partitions 1-M (labeled 421).

Each logical partition 411 may be configured to execute a query against one or more database partitions 421. For example, logical partition 1 may execute query 210 against database partitions 1 and 2, logical partition 2 may execute query 210 against database partition 3, and logical partition N may execute query 210 against database partitions 3 and M, as illustrated.

Each logical partition 411 may be controlled by an operating system. For example, logical partition 1 is controlled by operating system (OS) 1, logical partition 2 is controlled by OS 2, operating system N is controlled by OS N, and so on. The operating systems 1-N may correspond to operating systems 123 in FIG. 1.

Furthermore, each logical partition 411 may be allocated one or more resources of the system. The resources may include, for example, central processing units (CPUs), 10 ports and devices, a range of memory, and the like. For example, Logical partition is allocated CPU1, and memory region 1 in FIG. 4. Similarly, logical partition 2 and N are allocated CPUs 2 and N, and memory regions 2 and N, respectively. The CPUs 1-N may correspond to the CPUs 121 in FIG. 1.

Each logical partition 411 may also include an optimizer for executing queries. As previously discussed, the optimizers may generally be configured to determine the best access plan for each query they encounter, based on cost comparisons (i.e., estimated resource requirements, typically in terms of time and space) of available access plans. In selecting the access plan (and comparing associated costs), the optimizer may explore various ways to execute the query. For example, the optimizer may determine if an index may be used to speed a search, whether a search condition should be applied to a first table prior to joining the first table to a second table or whether to join the tables first.

One skilled in the art will recognize that different access plans may require different resources. For example, some access plans may require a greater use of memory, while other access plans may require a greater use of IO operations. The particular access plan selected may affect the time required to execute the query. In one embodiment of the invention, the optimizers may select the access plan that executes the query the fastest based on the resources available to the logical partition.

However, sometimes, even the best access plan based on available resources may not execute the query within a desired amount of time. For example, it may be desirable to execute a query, for example, query 210, within a threshold amount of time. However, the logical partition executing the query against the slowest database partition may not have sufficient resources to execute the query within the threshold amount of time.

Therefore, embodiments of the invention provide for dynamically allocating resources to the logical partition running the query against the slowest database partition to execute the query faster. For example, partition manager 131 may allocate more memory, CPU's, 10 ports, devices, and the like to the logical partition executing the query against the slowest database partition.

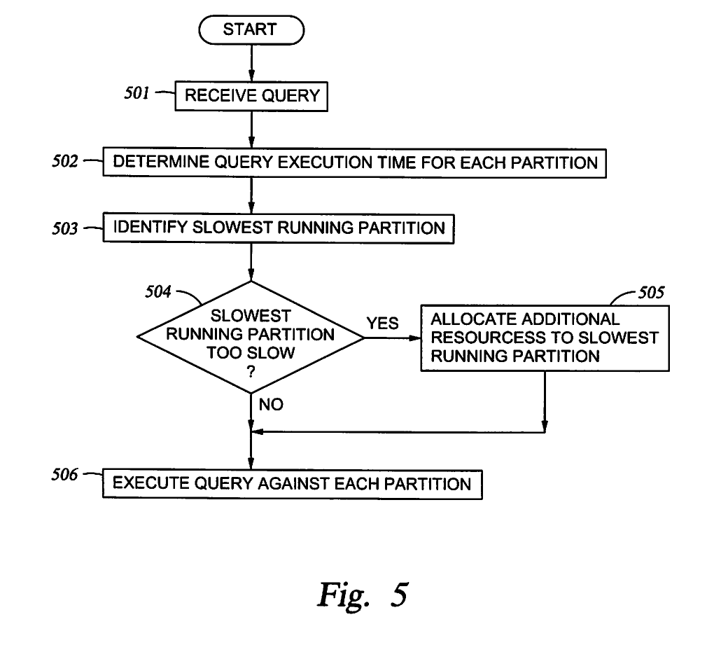

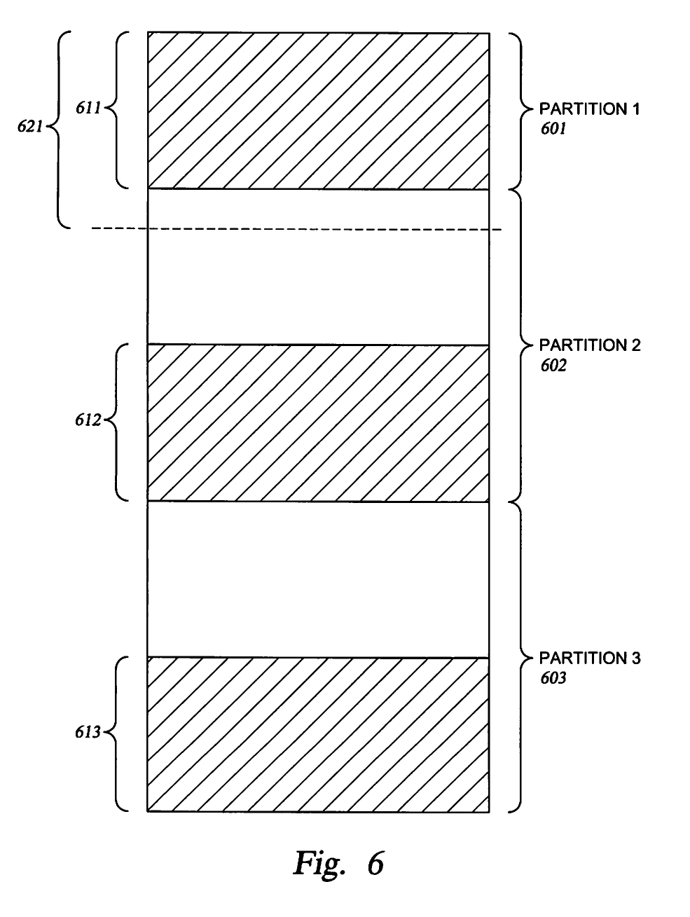

FIG. 5 is a flow diagram of exemplary operations performed by a partition manager to adjust allocation of resources to a logical partition. The operations may begin in step 501 by receiving a query. In step 502, the query execution time for each query may be determined. For example, an optimizer may identify a plurality of access plans for executing the query. In one embodiment, the optimizer may be configured to determine the access plan that returns results for the query the fastest based on available resources.

In step 503, the slowest running database partition may be determined. For example, optimizers associated with each logical partition may determine the fastest access plans based on the resources allocated to the respective logical partitions. The logical partition configured to execute the query against the slowest database partition may also be identified.

In step 504, the partition manager may determine whether the slowest running partition is running too slow. For example, in one embodiment, the partition manager may determine whether the slowest running database partition executes the query within a threshold amount of time. For example, the partition manager may receive data regarding query execution from one or more optimizers associated with logical partitions of a logically partitioned system. The query execution data may indicate the amount of time for executing the query against each database partition. The partition manager may identify the slowest database partition and determine whether the slowest database partition is too slow.

In one embodiment, the partition manager may determine whether the slowest running database partition is running too slow based on a comparison between the execution times for different database partitions. For example, the partition manager may compare the slowest running database partition to one or more faster running database partitions. Based on the comparison of the execution times, the partition manager may determine that the query is running too slow.

In one embodiment of the invention, the partition manager may determine whether the slowest running partition will run too slow based on historical query execution data. For example, referring back to FIG. 1, query data 129 may include historical execution times for the query. The partition manager may determine that the slowest running partition runs too slow based on an analysis of the historical query execution times. For example, the partition manager may compute an average execution time for each database partition, and determine whether the slowest running partition will run too slow.

In one embodiment of the invention, the optimizers associated with each logical partition may be configured to alert the partition manager if the slowest running database partition is too slow. For example, an optimizer may determine an access plan for executing the query. If the access plan cannot execute the query in a threshold amount of time, the optimizer may alert the partition manager that the logical partition has insufficient resources to execute the query within the threshold amount of time.

In one embodiment of the invention, the optimizers associated with each partition may be in constant communication with the partition manager regarding the availability of resources for executing queries. For example, the optimizers may periodically alert the partition manager if there are insufficient or an overabundance of resources at their respective logical partitions for executing the query. The availability of resources at a logical partition may indicate whether the query will execute too slowly in that particular logical partition.

If, in step 504, it is determined that the slowest running partition will not run too slow, the query may be executed against the database partitions in step 506. If, however, it is determined that the slowest running partition will run too slow, in step 505, the partition manager may allocate one or more additional resources to the logical partition running the query against the slowest database partition. For example, the partition manager may allocate additional memory, CPUs, and the like to the logical partition.

Accordingly, an optimizer associated with the logical partition running the query against the slowest database partition may determine a new and faster query access plan for executing the query based on all available resources, including the newly allocated resources. The query may then be executed against the database partitions in step 406.

If additional resources are not available, the partition manager may communicate back to the optimizer of the logical partition executing the query against the slowest database partition indicating that additional resources are not available.

FIG. 6 illustrates an example of reallocation of memory to a logical partition according to an embodiment of the invention. As illustrated in FIG. 6, memory 600 may be divided into a plurality of regions, wherein each region is allocated to a particular logical partition. For example, in FIG. 6, region 601 is allocated to partition 1, region 602 is allocated to partition 2, and region 603 is allocated to partition 3, as illustrated.

Memory regions 611, 612, and 613 illustrate memory usage by the logical partitions during execution of a query. For example, region 611 indicates that partition 1 uses all of the allocated memory. However, blocks 612 and 613 indicate that partitions 2 and 3 use only a portion of the allocated memory, for example.

In some cases the memory allocated to a logical partition may not be sufficient to execute a query in a desired manner. For example, partition 1 may receive a query requiring significant memory usage. Memory region 601 may be insufficient to execute the query in a desired manner, for example, within a threshold amount of time. An optimizer associated with partition 1 may determine the amount of memory required to execute the query in a desired way. For example, the optimizer may determine that a memory region 621 is necessary for executing the query.

Therefore, the optimizer may request additional memory from the partition manager. In response to the request for additional memory from the optimizer, the partition manager may allocate region 621 to logical partition 1 for executing the query. To allocate resources of the system, partition manager may be configured to determine the status of resources at other logical partitions. For example, the partition manager may determine the usage of resources at other logical partitions. If a resource is not used or infrequently used at a logical partition, that resource may be selected for reallocation.

In one embodiment of the invention, the partition manager may allocate resources from a logical partition running a the query against a fast database partition to a logical partition executing the query against a slow database partition, thereby slowing execution of the query against the fast database partition. Therefore, a more uniform query execution time for the database partitions may be achieved.

One skilled in the art will recognize that embodiments of the invention are not limited to reallocation of memory. Any other resource, for example, CPUs, 10 devices, and the like, or any combination of resources may be reallocated based on the requirements for speeding up execution of a query against a slow database partition.

### CONCLUSION

By allowing reallocation of resources of database partitions on the basis of query execution time, embodiments of the invention reduce query execution time, and therefore improve query throughput.

While the foregoing is directed to embodiments of the present invention, other and further embodiments of the invention may be devised without departing from the basic scope thereof, and the scope thereof is determined by the claims that follow.

What is claimed is:

1. A method for executing a query, comprising:
determining a query resource requirement for execution of the query in a partitioned data environment having a plurality of data partitions;
adjusting allocation of resources to one or more logical partitions executing the query against one or more data partitions based on the determined query resource requirement; and
executing the query in a plurality of logical partitions including the one or more logical partitions for which resources were adjusted.

2. The method of claim 1, wherein determining a query resource requirement comprises determining, for each data partition, a query execution time, and one or more resources required for executing the query against the data partition within the determined query execution time.

3. The method of claim 2, wherein determining the query execution time comprises determining an average execution time of the query against the data partition based on historical executions of the query.

4. The method of claim 2, wherein determining the query execution time comprises determining resources available to the logical partition executing the query against the data partition and determining an access plan to execute the query.

5. The method of claim 1, wherein adjusting allocation of resources comprises determining one or more resources that are not being used and allocating the one or more resources to the one or more logical partitions.

6. The method of claim 1, wherein the resources comprise central processing units, memory, and input/output devices.

7. A computer readable medium containing a program for executing a query which, when executed, performs an operation, comprising:
determining a query resource requirement for execution of the query in a partitioned data environment having a plurality of data partitions;
adjusting allocation of resources to one or more logical partitions executing the query against one or more data partitions based on the determined query resource requirement; and
executing the query in a plurality of logical partitions including the one or more logical partitions for which resources were adjusted.

8. The computer readable medium of claim 7, wherein determining a query resource requirement comprises determining, for each data partition, a query execution time and one or more resources required for executing the query against the data partition within the determined query execution time.

9. The computer readable medium of claim 7, wherein determining the query execution time comprises determining an average execution time of the query against the data partition based on historical executions of the query.

10. The computer readable medium of claim 7, wherein determining the query execution time comprises determining resources available to the logical partition executing the query against the data partition and determining an access plan to execute the query.

11. The computer readable medium of claim 7, wherein adjusting allocation of resources comprises determining one or more resources that are not being used and allocating the one or more resources to the one or more logical partitions.

12. The computer readable medium of claim 7, wherein the resources comprise central processing units, memory, and input/output devices.

13. A system, comprising:
a database comprising a plurality of data partitions;
a plurality of logical partitions, wherein each logical partition is configured to execute a query against one or more data partitions; and
a partition manager configured to:
adjust allocation of resources to one or more logical partitions executing the query against one or more data partitions based on a query resource requirement for executing the query; and
execute the query in the plurality of logical partitions including the one or more logical partitions for which resources were adjusted.

14. The system of claim 13, further comprising an optimizer associated with each logical partition, wherein the optimizer is configured to determine the query resource requirement for one or more data partitions.

15. The system of claim 14, wherein the optimizer is configured to determine the query resource requirement by determining a query execution time and one or more resources required for executing the query against the data partition within the determined query execution time.

16. The system of claim 15, wherein the optimizer is configured to determine the query execution time by determining resources available to the logical partition executing the query against the data partition and determining an access plan to execute the query.

17. The system of claim 14, wherein the optimizer is configured to determine an average execution time of the query against the data partition based on historical executions of the query.

18. The system of claim 14, wherein the optimizer is configured to send a request to the partition manager, wherein the request requests allocation of additional resources.

19. The system of claim 13, wherein the partition manager is configured to adjust allocation of resources by determining one or more resources that are not being used and allocating the one or more resources to the one or more logical partitions

20. The system of claim 13, wherein the resources comprise central processing units, memory, and input/output devices.
